(19) United States
(12) Patent Application Publication
(10) Pub. No.: US 2023/0144802 A1
(43) Pub. Date: May 11, 2023

(54) Data Free Neural Network Pruning

(71) Applicant: Deeplite Inc., Montreal (CA)

(72) Inventors: Martin FERIANC, Montreal (CA); Anush SANKARAN, Montreal (CA); Olivier MASTROPIETRO, Montreal (CA); Ehsan SABOORI, Montreal (CA); Davis Mangan SAWYER, Montreal (CA)

(73) Assignee: Deeplite Inc., Montreal (CA)

(21) Appl. No.: 18/054,390

(22) Filed: Nov. 10, 2022

Related U.S. Application Data
(60) Provisional application No. 63/278,252, filed on Nov. 11, 2021.

(51) Int. Cl. G06N 3/08

(52) U.S. Cl. CPC G06N 3/082

(57) ABSTRACT

A system, method and computer readable medium are provided for implementing data free neural network pruning. The illustrative method include determining mutual information between outputs of two or more of the plurality neurons and a respective two or more inputs used to generate the outputs, the two or more neurons being activated as a result of synthetically created inputs for measuring entropy. The method includes determining a sparser neural network by pruning the plurality of neurons based on the determined mutual information.

### CROSS-REFERENCE TO RELATED APPLICATION(S)

This application claims priority to U.S. Provisional Application No. 63/278,252 filed on Nov. 11, 2021, the entire contents of which are incorporated herein by reference.

### TECHNICAL FIELD

The following generally relates generally to neural network pruning, and particularly to data free neural network pruning.

### BACKGROUND

Neural networks (NNs) have been successfully deployed in several applications, such as computer vision [14] or natural language processing [1]. NNs' accuracy in these tasks increases with ongoing development, however, so does their size and power consumption [4]. Novel NNs' increasing size, complexity, and energy demands limit their deployment to compute platforms which are not available to the general public.

On one hand, hardware optimizations have been proposed to ease the deployment of demanding NNs, but these are usually targeting a specific pair of an NN architecture and a hardware platform [2]. On the other hand, software optimizations, such as structured pruning [6] have been proposed, which can be applied to a variety of NNs to make them sparser. In structured pruning, a certain neuron in the NN is removed completely, saving computation time, reducing the NN's memory and energy consumption on almost any hardware [10]. For example, by structured pruning and subsequent fine-tuning, ResNet-18's compute operations' count can be reduced by, for example, 7 times and its memory footprint by, for example, 4.5 times [10]. Known methods for structured pruning are limited and based on inconclusive heuristics. For example, the exiting methods might require having access to the original data on which the NN was trained for fine-tuning.

In addition, known methods are limited in that they provide little to no insight, or are based on little to no insight about the internal structural relationships within the NNs. Alternatively stated, known methods provide a limited understanding of the sensitivity of structural components of the NN to certain inputs.

It is an object of the following to address at least one of the above-noted disadvantages.

### SUMMARY

To potentially address the above-noted defects, the following proposes a data free approach to structured pruning which is facilitated through causal inference. In this approach, the system evaluates the importance of different neurons through measuring mutual information (MI) under a maximum entropy perturbation (MEP) propagated through the NN. In addition, the method may provide additional insight into the causal relationships between elements of the NN, facilitating a better understanding of the system sensitivity. Experimental results are included herein, and demonstrate performance and generalisability on various fully-connected NN architectures on two datasets. Experimental testing to date indicates that this method can be more accurate (e.g., outscore related work) in challenging settings where the NN is small and shallow.

In one aspect, there is provided a method for pruning a neural network comprised of a plurality of neurons. The method includes determining mutual information between outputs of two or more of the plurality of neurons and a respective two or more inputs used to generate the outputs, the two or more neurons being activated as a result of synthetically created inputs for measuring entropy. The method includes determining a sparser neural network by pruning the plurality of neurons based on the determined mutual information.

In example embodiments, the two or more inputs are synthetically created based on a distribution that captures all possible input values within a fixed range. The two or more inputs can be populated by sampling the distribution. The distribution can be a Gaussian distribution.

In example embodiments, determining mutual information includes activating the neural network with the synthetically created inputs. The method includes caching outputs of the plurality of neurons generated in response to the activation, and determining mutual information based on the cached outputs.

In example embodiments, the two or more neurons are in a layer of the neural network, and the method further includes pruning a neuron of two or more neurons having a lower determined mutual information. The method can iteratively prune another layer of the neural network based on determined mutual information of two or more neurons in the other layer. In example embodiments, determined mutual information of the two or more neurons in the other layer is independent of the two or more neurons in the layer.

In example embodiments, each neuron of the two or more neurons outputs two or more neuron specific outputs based on receiving two or more neuron specific inputs.

In example embodiments, the mutual information is determined per input-output for the neuron.

In another aspect, a system for pruning a neural network comprised of a plurality of neurons is disclosed. The system includes a processor and memory. The memory includes computer executable instructions which cause the processor to determine mutual information between outputs of two or more of the plurality of neurons and a respective two or more inputs used to generate the outputs, the two or more neurons being activated as a result of synthetically created inputs for measuring entropy. The memory causes the processor to determine a sparser neural network by pruning the plurality of neurons based on the determined mutual information.

In example embodiments, the two or more inputs are synthetically created based on a distribution that captures all possible input values within a fixed range. The two or more inputs can be populated by sampling the distribution.

In example embodiments, the processor, to determine mutual information activates the neural network with the synthetically created inputs, and caches outputs of the plurality of neurons generated in response to the activation. The processor determines mutual information based on the cached outputs.

In example embodiments, the two or more neurons are in a layer of the neural network, and the processor prunes a neuron of two or more neurons having a lower determined mutual information. In example embodiments, the processor iteratively prunes another layer of the neural network based on determined mutual information of two or more neurons in the other layer. In example embodiments, determined mutual information of the two or more neurons in the other layer is independent of the two or more neurons in the layer

In example embodiments, each neuron of the two or more neurons outputs two or more neuron specific outputs based on receiving two or more neuron specific inputs.

In example embodiments, the mutual information is determined per input-output for the neuron.

In yet another aspect, a computer readable medium storing computer executable instructions is disclosed. The instructions cause a processor to determine mutual information between outputs of two or more of a plurality of neurons and a respective two or more inputs used to generate the outputs, the two or more neurons being activated as a result of synthetically created inputs for measuring entropy. The instructions cause a processor to determine a sparser neural network by pruning the plurality of neurons based on the determined mutual information.

### BRIEF DESCRIPTION OF THE DRAWINGS

Embodiments will now be described with reference to the appended drawings wherein:

FIGS. 1A, 1B, and 1C illustrate an example simplified NN, and components thereof, for discussing a simplified example of structured pruning in accordance with the disclosure herein.

FIG. 2 illustrates an algorithm for performing inference of MI scores for structured pruning.

FIGS. 3A and 3B illustrate CIFAR-10 test dataset results, wherein each box includes an aggregation of all twelve (12) networks pruned with respect to a set percentage.

FIGS. 4A and 4B illustrate SVHN test dataset results, wherein each box includes an aggregation of all twelve (12) networks pruned with respect to the set percentage.

FIGS. 5A and 5B together show a plot comparing error rate to pruning percentage for a network with one hidden layer with sixty-four (64) channels for CIFAR-10.

FIGS. 6A and 6B together show a plot comparing error rate to pruning percentage for a network with one hidden layer with sixteen (16) channels for SVHN.

FIG. 7 is a block diagram illustrating a system in which an optimized NN can be used.

### DETAILED DESCRIPTION

NNs are making large impact both on research and within various industries. Nevertheless, as the accuracy of NNs increases, it is followed by an expansion in their size, required number of compute operations, and associated energy consumption. An increase in resource consumption results in NNs' reduced adoption rate and real-world deployment impracticality. Therefore, NNs need to be compressed to make them available to a wider audience and at the same time decrease their runtime costs.

Another problem with the larger NNs is the difficulty of meaningfully assesses their sensitivity to certain inputs, as the internal workings of larger NNs are more opaque due to increased complexity.

In the following, at least some of the above challenges are approached from a causal inference perspective, with a scoring mechanism developed to facilitate structured pruning of NNs. The approach is based on measuring MI under a MEP, sequentially propagated through the NN. The disclosed method's performance can be demonstrated on two datasets and various NNs' sizes, and it can be shown that the present approach achieves competitive performance under challenging conditions.

### Causal Inference and Information Bottleneck

The present method builds and improves upon the work of [7] who have proposed a suite of metrics based on information theory—to quantify and track changes in the causal structure of NNs. In [7] the notion of effective information, the MI between layer input and output following a local layer-wise MEP, was introduced.

However, the method disclosed in [7] is challenging to implement. The method in [7] requires the complexity of introducing a local layer-wise MEP. This is an intuitive approach, as the sequential evaluation of nodes is paired with the sequential introduction of MEP. However, this approach is computationally expensive, and requires multiple input sampling rounds.

In addition, the approach in [7] focuses on layer-by-layer assessments of casual relationships. Therefore, the approach is of limited use for more nuances structural pruning (e.g., such as the structural pruning proposed here, which may be used to reduce neurons within a layer).

The present method introduces several unintuitive changes relative to [7].

First, the method disclosed herein samples a random intervention only at the input of the NN. This is counter-intuitive, as it is presumed that introducing MEP at the node level will provide better results. However, as discussed herein, the disclosed method manages comparable performance notwithstanding the decision to into introduce MEP at the input. This adaptation can potentially reduce implementation and computational complexity (and bias associated with the chosen MEP distribution), as sampling is only performed for the input.

Second, the disclosed method selects a different MEP: a Gaussian distribution (instead of a uniform one) that more closely reflects real-world data. By selecting a Gaussian distribution for MEP, and introducing it at the input stage, the proposed method can possibly enable NN pruning that is more responsive to real-world conditions. That is, in contrast to [7], and as is shown experimentally, the combination of the two differences discussed herein can provide comparable accuracy with less computational resources. With Gaussian noise propagated through the NN, the neurons which maximize the MI between input and output are preferred with respect to evaluation on the test data

Third, the disclosed method combines the different measurements per neural connection, and uses them to score the likeliness of that neuron, for structured pruning. In the disclosed method, the MI is measured with respect to the output of the previous layer obtained by propagating the intervention throughout the net.

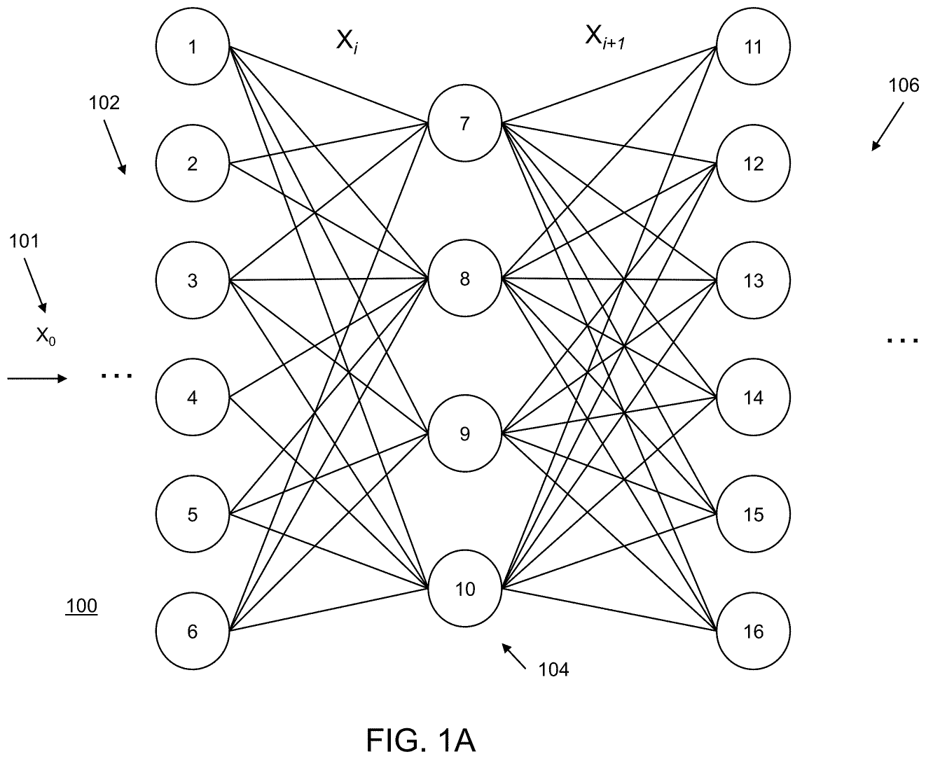

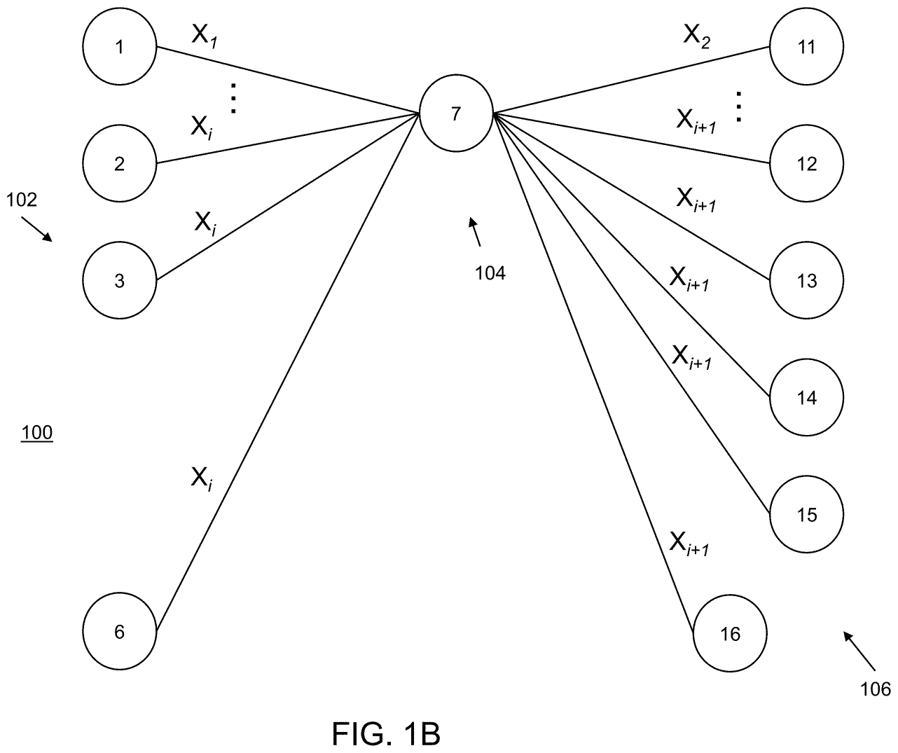

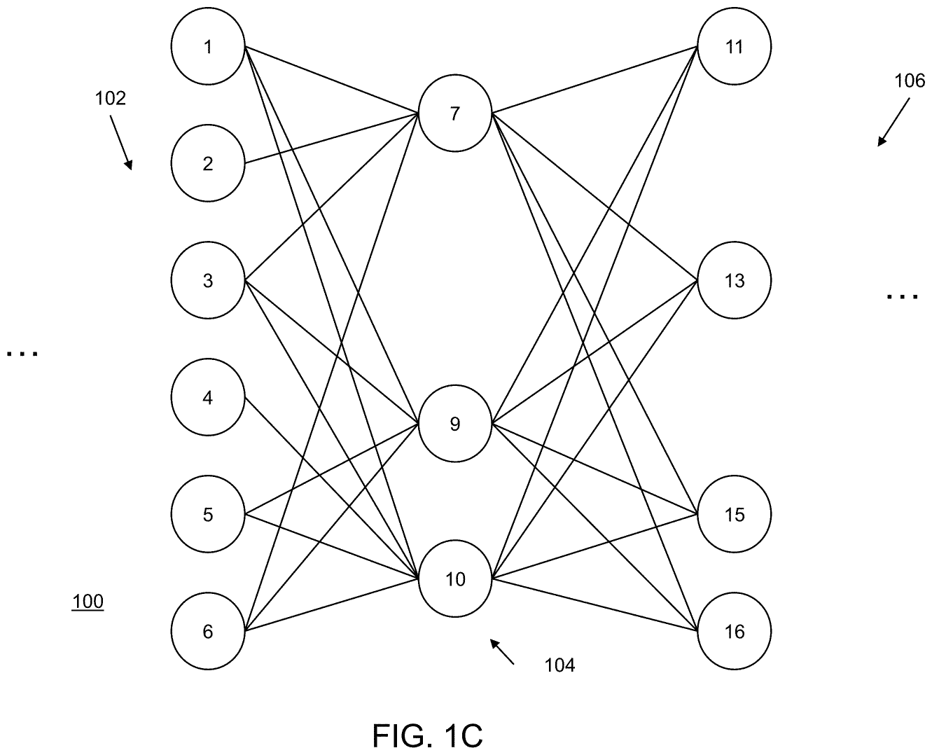

Referring now to the illustrative example network shown in FIGS. 1A, 1B, and 1C, the proposed method measures the MI between outputs from the layer 102, denoted by Xᵢ, and the outputs from the layer 104, denoted by Xᵢ₊₁. It is understood that the NN shown in FIGS. 1A, 1B, and 1C is intentionally simplified for illustrative purposes, and that the disclosed method cannot practically be performed by the human mind when implemented outside of the simplified illustrative example.

Additional concepts related to or adopted by the present method include information bottleneck [12], which measures MI with respect to the information plane and propagating data through the network. In this approach, they have shown that at a certain point in the NN, the NN minimizes MI between input and output.

### Structured Data Free Pruning

Reference [6] completed a comprehensive survey of NN pruning methods. In the present disclosure, focus is put on pruning methods that do not require data to prune and on structured pruning. [11] proposed a data-free pruning (DFP) method that examines the importance of different neurons based on their similarity through the magnitude of their weights. Their method iteratively examines, prunes and updates this similarity along with the weights of the NN. [8] proposed a data-independent way for pruning neurons in an NN through coreset approximation in its preceding layers. [13] developed correlation-based pruning (COP), which can detect the redundant neurons efficiently through removing the ones which are the most correlated with the others. Moreover, [9] developed a method to reason over NN as a structured causal model, nevertheless, this method is data-bound. Lastly, [3] introduced MINT which is based on measuring MI with respect to data, however, without considering the notion of causal inference or MEP.

With respect to the above-described related work, the present method also aims to appeal to users who seek data free pruning methods, potentially due to privacy-related constraints. To provide an example, the disclosed method can be used to prune a NN used for image processing, wherein the input vector representing the image can be populated by sampling the MEP.

While the presently disclosed method is data-free, it notably differs from previous methods by avoiding reliance on heuristics, such as the weight magnitude or correlation. Instead, the method relies on examining the causal structure in the NN, rather than deterministic heuristics.

### Causal Inference Based Approach

Without accessing the data, NNs and their internal connectivity have been often described through heuristics, such as correlations and magnitude of the connecting weights for the individual neurons [6]. As the depth and width of the NNs increase, these metrics become less transparent and interpretative in feature space. Additionally, there is no clear link between these heuristics and the causal structure by which the NN makes decisions and generalizes beyond training data. Yet, generalizability should be a function of a NN's causal structure since it reflects how the NN responds to unseen or even not-yet-defined future inputs [7]. Therefore, from a causal perspective, the neurons which are identified to be more impactful in the architecture should be preserved and the ones that are identified less important could be removed. This paradigm paves the way for observing the causal structure, identifying important connections and subsequent structured pruning in NNs, replacing heuristics, to achieve better generalization.

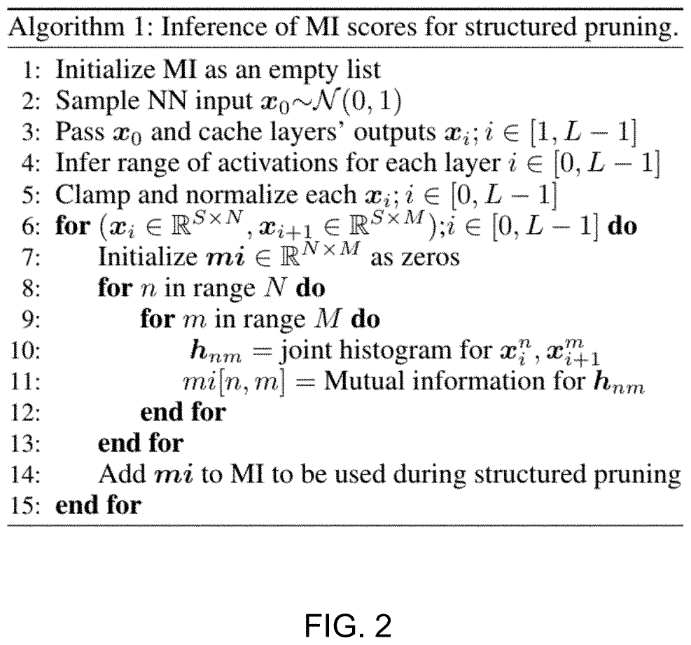

In the following, there is proposed a perturbation-based approach to examining the causal structure of the NN, which enables a system to quantify the significance of each neuron in a layer for all layers in the NN. An example of the proposed approach is documented in FIG. 2, which illustrates an example algorithm for performing inference of MI scores for structured pruning. The example of FIG. 2 shall be discussed with reference to FIGS. 1A, 1B, and 1C, below. It is understood that the reference to FIGS. 1A, 1B, and 1C, is illustrative, and not limiting.

The method performs an intervention do(x) at the input level (with the resulting input shown as input 101 in FIG. 1A) of the NN 100. The input 101 is propagated to deeper layers, such as layers 102, 104, and 106 to reveal their causal structure. The resulting input 101 is generated by a MEP—a Gaussian distribution, which covers the space of all potential interventions with a fixed variance, instead of choosing a single type of intervention.

The method then measures MI between the input and output pairs (again, at the neuron level, and not the layer level, as in [7]) to measure the strength of their causal interactions. In an example (FIG. 1B), the method measures the MI between each of the inputs Xᵢ to the layer 104 (the inputs themselves being outputs from neurons in the layer 102), and the outputs Xᵢ₊₁ of the layer 104. That is, the MI is measured per input-output connection for computational and MI estimation simplicity. Unintuitively, this approach moves away from assessing MI on a layer-by-layer level, as it implies that each output MI is independent with respect to other input connections. For example, this approach ignores directly assessing the degeneracy of the network disclosed in [7].

The individual scores for all input connections for that particular node (e.g., node 7 in the layer 104 in FIG. 1B) are summed to give that particular neuron a score. This process is followed for each neuron in each layer. For example, each of neurons 7 to 10 are assessed for layer 104 in FIG. 1A.

The proposed method is based on the hypothesis, which has at least in part been validated experimentally, as disclosed herein, that the connections that can preserve the most information on average under MEP are the strongest and they should be preserved in case of pruning. Therefore, the neurons in the layer with the least cumulative MI, are candidates for pruning. In example embodiments, all neurons within a layer having an MI below a threshold (e.g., a cumulative MI below a certain amount), or which satisfy a set of parameters (e.g., parameters related to thresholds on a per layer level (e.g., average MI for the layer), and parameters related to thresholds on NN level (e.g., average MI for the NN)) can be used depending upon the pruning strategy selected. In example embodiments, as discussed in respect of the experiments, consistent parameters between layers can be used (e.g., pruning 15%), or different parameters can be used for different layers of the NN 100.

For example, referring to FIG. 1C, the neurons from the layer 104 in FIG. 1A are pruned based on the lowest determined neuron score in the layer 104 (i.e., based on the MI), which results in neuron 8 being removed.

While it would appear intuitive to trim the NN 100 globally, as the noise is passed through the NN 100 as a result of the single input 101 and the outputs of the layers are cached, experiments indicate that the pruning is more successful when carried out layer-by-layer.

Algorithm 1, illustrated in FIG. 2, summarizes example computer implementable instructions that can be used to perform an example implementation of the disclosed method. The example method begins with propagating the random noise through the network (based on the MEP), while caching, clamping and normalizing the outputs of neurons between [0,1] with respect to the inferred range of activations, since MI is invariant to affine transformations. Then, for each input xᵢ and output x₁₊₁ pair with S samples, out of L layers in the NN, and for each input out of N neurons and output neuron out of M neurons, their interactions are captured in a joint histogram which is used to calculate their MI with respect to B times B bins. This process is repeated, and the matrix recorded for each layer in a list. During pruning, the individual appended matrices are first zeroed with respect to any previously pruned connections (in order to isolate the impact of other layers on a particular layer), given by pruning the previous layer. The final score for a layer is then given by summing the matrix row-wise with respect to each output neuron. The score is then sorted and the neurons with the smallest score are pruned, moving to the next layer. Hence, the overall algorithm focuses on preserving the neurons that should have the most impact on the generalization performance of the NN without requiring any data or heuristics.

### Experimental Analysis

To validate the proposed method, comprehensive experiments were performed, involving two datasets and various network depths and widths. The experiments were conducted with respect to CIFAR-10 and SVHN, to vary the complexity of the datasets, without any data augmentations except normalization. For both datasets in total 12 networks were trained, paired with ReLU activations, with {1,2,3} hidden layers and {64, 128, 192, 256} channels for CIFAR-10 or {16, 32, 48, 64} channels for SVHN, giving 12 model combinations for each dataset. The models were arguably small, where it can be assumed that each neuron has certain importance and there are no or few inactive neurons. Therefore, the pruning methods should be careful about scoring the neurons, since removing even a single neuron will affect the algorithmic performance. In terms of pruning, each compared method: magnitude-based [5], Random, COP, DFP, coreset, or the present method (MI) is considered to provide a relative importance score for all hidden neurons in an NN. Publicly available implementations of the respective methods were used, with the exception being DFP which was reimplemented. A linearly increasing pruning schedule was adopted with respect to depth of a layer with some maximum percentage, omitting the input layer. For example, if one sets the pruning rate to 30% and the network has 2 hidden layers, each compared method would prune 15% of neurons in the first hidden layer and 30% in the second hidden layer depending on the lowest scores given by each method. The method used S=5000 samples for MI estimation with B=32.

### Aggregated Results

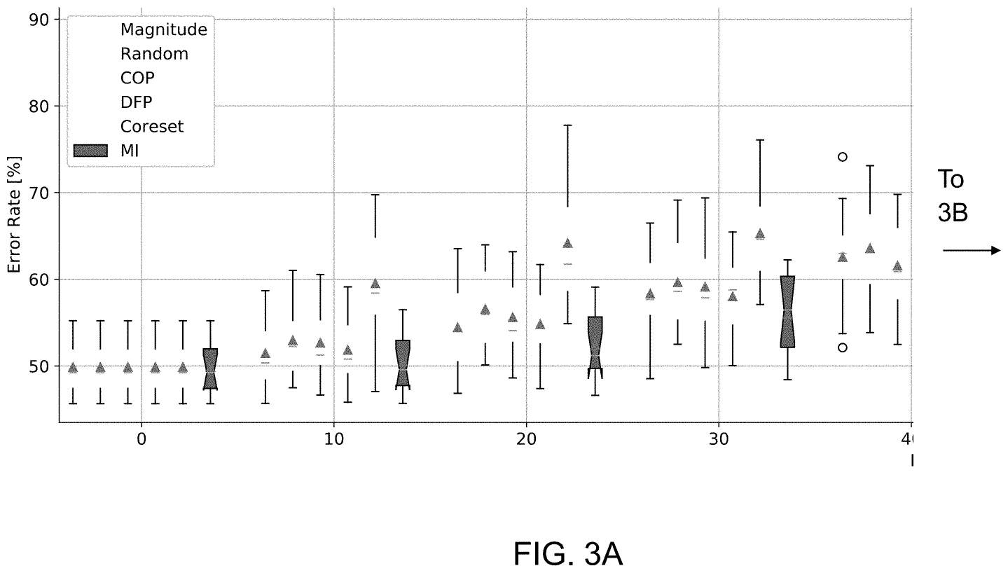

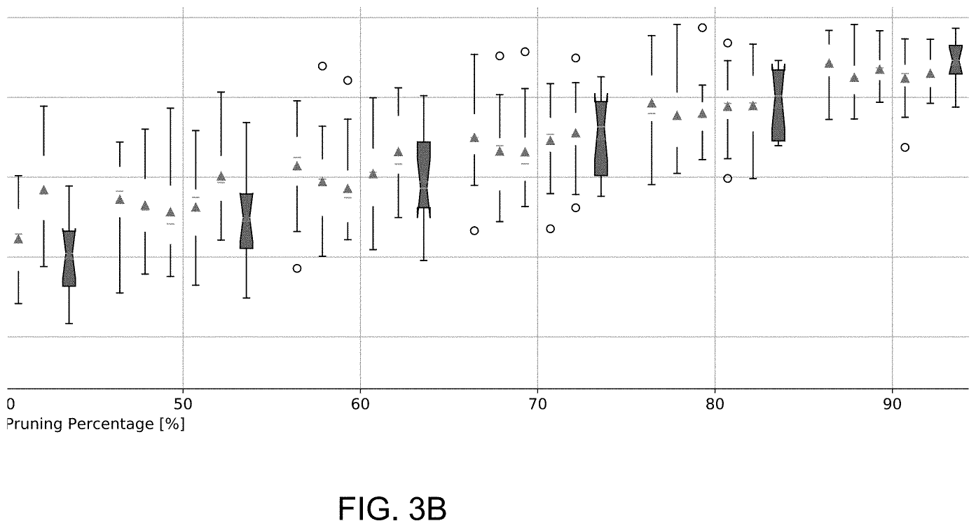

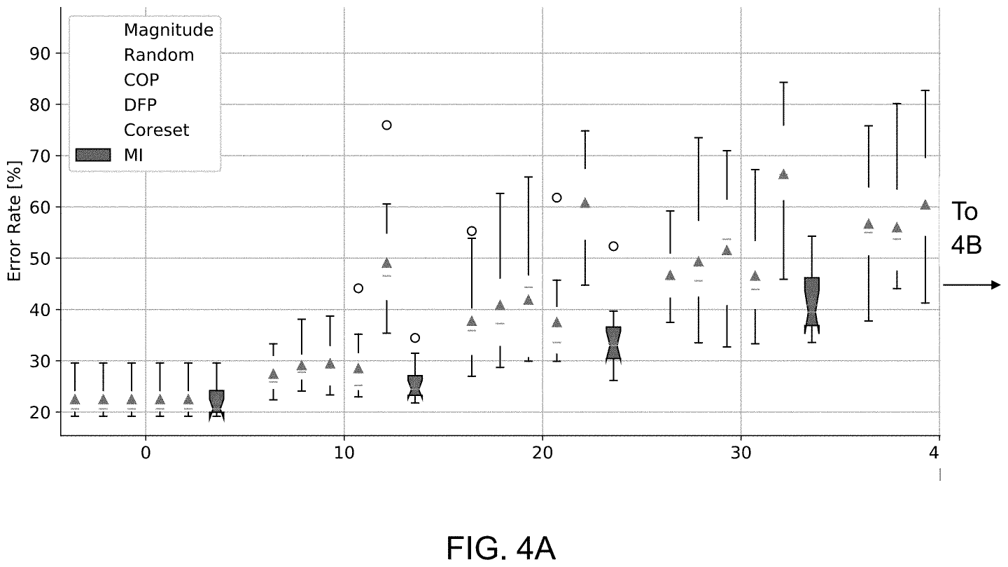

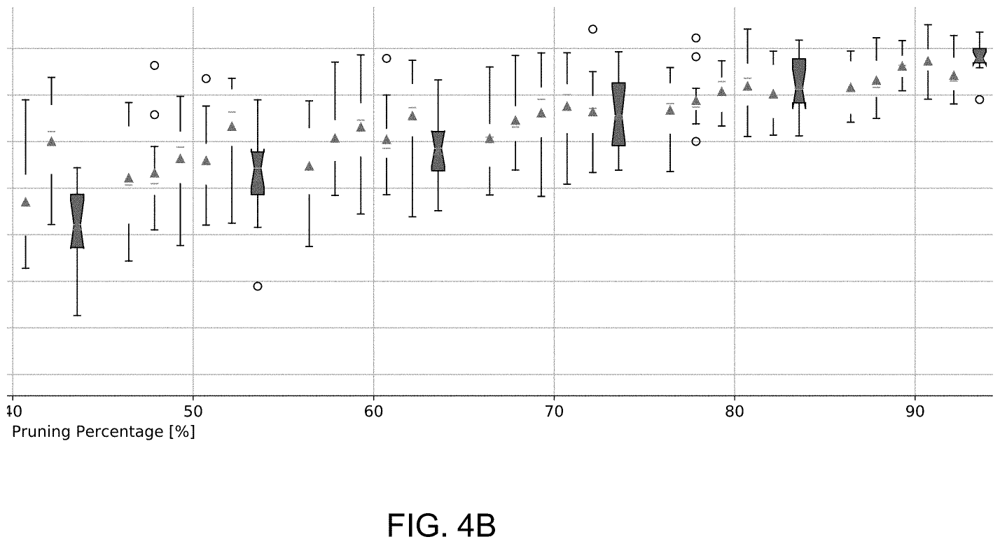

In FIGS. 3A, 3B, 4A and 4B, the results demonstrate varying error rate across different limiting pruning percentages. Each box represents aggregated results from twelve (12) benchmarked models pruned with respect to the limiting percentage. This form of presentation was chosen to demonstrate the versatility of the present method and related work across different network depths and widths. As it can be seen with respect to both datasets, the present method's error rates increase less in comparison to the related work across a range of different architectures and pruning percentages, signifying its functionality across a spectra of network structures.

### Detailed Results

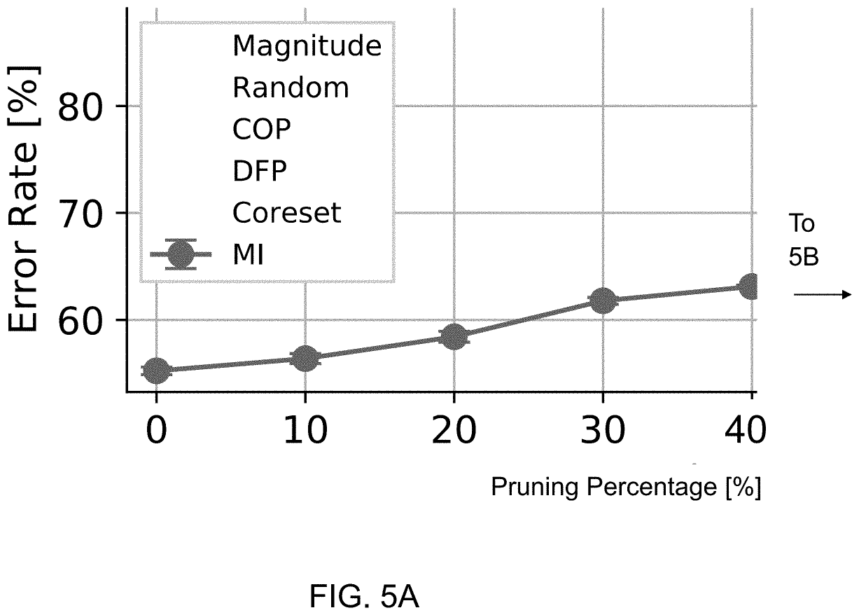

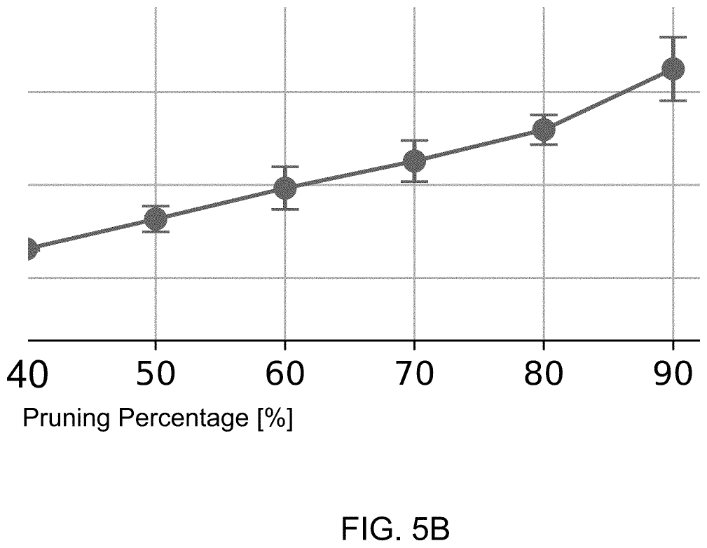

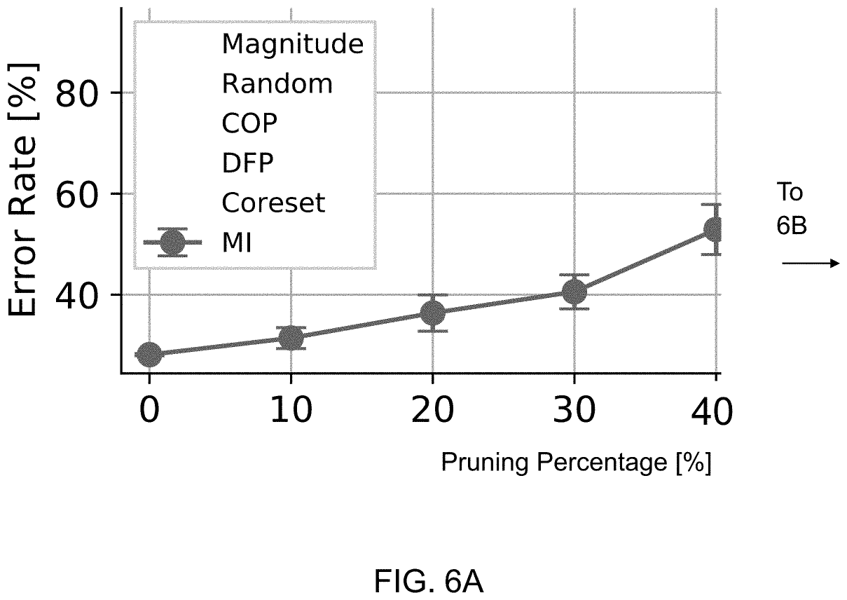

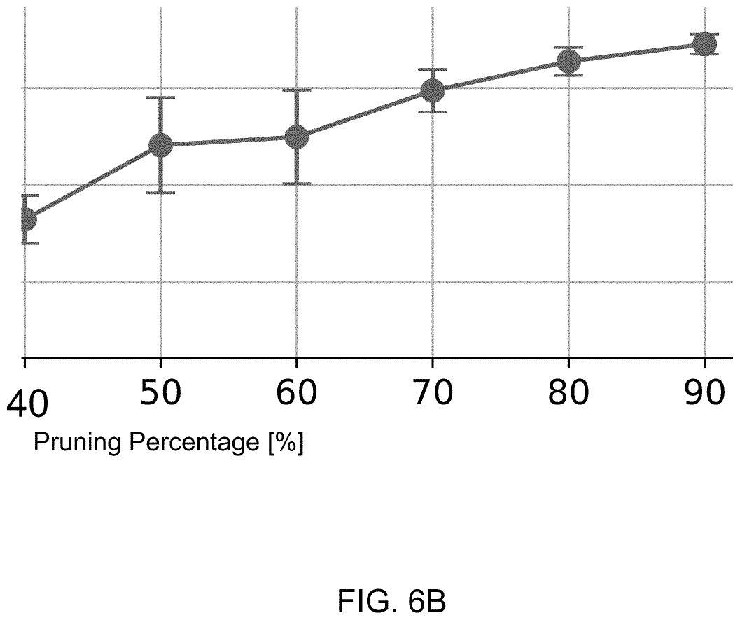

In FIGS. 5A, 5B, 6A and 6B the results are presented with respect to the smallest and most challenging architectures in the experiments with only one hidden layer. All experiments were repeated three (3) times with different random seeds to observe mean and standard deviation for robustness. As it can be seen, MI was able to more concretely identify the significant neurons, resulting in lower average error rates, mainly for CIFAR-10.

TABLE 1
Ranking similarity to magnitude-based score for the
deepest and widest network variants

| | CIFAR-10 | | SVHN | |
|---|---|---|---|---|
| | Correlation | Kendall τ | Correlation | Kendall τ |
| Layer 1 | 0.86 ± 0.006 | 0.78 ± 0.01 | 0.5 ± 0.06 | 0.3 ± 0.05 |
| Layer 2 | 0.5 ± 0.1 | −0.15 ± 0.04 | −0.29 ± 0.05 | −0.2 ± 0.03 |
| Layer 3 | 0.6 ± 0.06 | 0.02 ± 0.04 | −0.08 ± 0.68 | −0.3 ± 0.16 |
| Layer 4 | 0.9 ± 0.0 | 0.47 ± 0.02 | 0.74 ± 0.1 | 0.05 ± 0.1 |

TABLE 2
Ranking similarity to magnitude-based score
for the shallowest and thinnest network variants

| | CIFAR-10 | | SVHN | |
|---|---|---|---|---|
| | Correlation | Kendall τ | Correlation | Kendall τ |
| Layer 1 | 0.418 ± 0.07 | 0.32 ± 0.05 | 0.11 ± 0.08 | 0.06 ± 0.12 |
| Layer 2 | −0.43 ± 0.02 | −0.23 ± 0.05 | −0.01 ± 0.43 | 0.05 ± 0.42 |

Additionally, in Tables 1 and 2 the Spearman correlation and Kendall tau ranking correlation are demonstrated with respect to magnitude-based pruning, which is a well-established baseline, to provide deeper insight into the proposed method. As it can be seen, the method is partially correlated to the magnitude of the weights connecting that neuron to the rest of the NN. However, looking simultaneously at the Kendall tau comparing weight magnitude and our score, it can be seen that the overall ranking is completely different. These results demonstrate that causal inference and MI in general are particularly important for deeper understanding of the structure of the NN and there is only a relatively weak connection to the weights' magnitudes.

### Challenging Settings

In the present disclosure, empirical first steps towards a causal inference-based approach for data free structured NN pruning are presented. The proposed methodology was evaluated with respect to different NN structures on two real-world datasets. Additionally, exceptionally successful cases for pruning were presented, as well as challenging conditions. However, overall, a fair algorithmic performance across different network sizes was demonstrated. The present method can be further extended with respect to complex networks, specifically convolutional NNs, and larger datasets.

### Example System Configuration

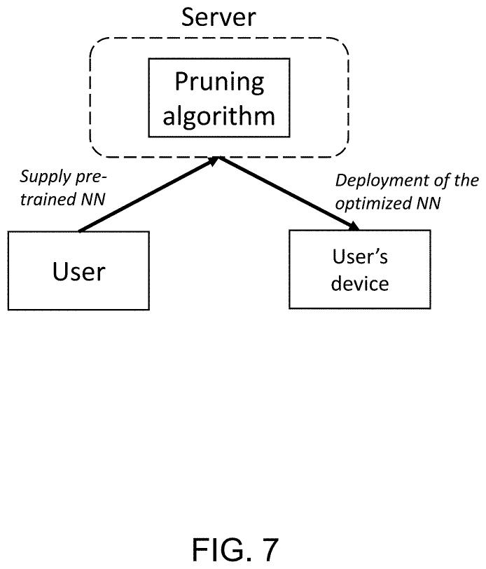

Referring now to FIG. 7, a system is shown in which a NN can be subjected to a pruning algorithm per the methods described herein and used in an application. In this example configuration, a computer server hosts the pruning algorithm which can be accessed via a network or other electronic communication connection to permit a pre-trained NN to be supplied thereto by a user. The user can supply this pre-trained NN using the same device for which the optimized NN is used, or another separate device. The pruning algorithm applies the principles described above to generate the optimized NN which can be deployed onto a user's device. It can be appreciated that the user's device can be associated with the same user that supplied the pre-trained NN or a different user.

An application where a user might wish to use their NN is for image classification. In such an example, a user could pre-train their NN with respect to their own resources. Next, the user supplies the pre-trained NN through the internet (or other network) to a server solution, or a resource with a similar compute power, where the pruning algorithm would be hosted and queried. The pruning algorithm would optimize the NN without requiring the user data (i.e., explaining why storage/data are not shown as mandatory) on that server. Subsequently, the pruned NN, with potentially better hardware performance, would be deployed on user's device to perform image classification directly on-device, not requiring any further connection.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the server or user's device, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

### REFERENCES

[1] Brown, T. B.; Mann, B.; Ryder, N.; Subbiah, M.; Kaplan, J.; Dhariwal, P.; Neelakantan, A.; Shyam, P.; Sastry, G.; Askell, A.; et al. 2020. Language models are few-shot learners. arXiv preprint arXiv:2005.14165.
[2] Chen, Y.; Xie, Y.; Song, L.; Chen, F.; and Tang, T. 2020. A survey of accelerator architectures for deep neural networks. Engineering, 6(3): 264-274.
[3] Ganesh, M. R.; Corso, J. J.; and Sekeh, S. Y. 2021. MINT: Deep Network Compression via Mutual Information-based Neuron Trimming. In Proceedings of the International Conference on Pattern Recognition (ICPR), 8251-8258. IEEE.
[4] Guo, Q.; Chen, S.; Xie, X.; Ma, L.; Hu, Q.; Liu, H.; Liu, Y.; Zhao, J.; and Li, X. 2019. An empirical study towards characterizing deep learning development and deployment across different frameworks and platforms. In Proceedings of the International Conference on Automated Software Engineering (ASE), 810-822. IEEE.
[5] He, Y.; Zhang, X.; and Sun, J. 2017. Channel pruning for accelerating very deep neural networks. In Proceedings of the IEEE International Conference on Computer Vision (ICCV), 1389-1397. IEEE.
[6] Hoefler, T.; Alistarh, D.; Ben-Nun, T.; Dryden, N.; and Peste, A. 2021. Sparsity in Deep Learning: Pruning and growth for efficient inference and training in neural networks. arXiv preprint arXiv:2102.00554.
[7] Mattsson, S.; Michaud, E. J.; and Hoel, E. 2020. Examining the causal structures of deep neural networks using information theory. arXiv preprint arXiv:2010.13871.
[8] Mussay, B.; Osadchy, M.; Braverman, V.; Zhou, S.; and Feldman, D. 2019. Data-independent neural pruning via coresets. arXiv preprint arXiv:1907.04018.
[9] Narendra, T.; Sankaran, A.; Vijaykeerthy, D.; and Mani, S.2018. Explaining deep learning models using causal inference. arXiv preprint arXiv:1811.04376.
[10] Sankaran, A.; Mastropietro, O.; Saboori, E.; Idris, Y.;Sawyer, D.; Askari Hemmat, M. H.; and Hacene, G. B.2021. Deeplite Neutrino: An End-to-End Framework for Constrained Deep Learning Model Optimization. arXiv preprint arXiv:2101.04073.
[11] Srinivas, S.; and Babu, R. V. 2015.Data-free parameter pruning for deep neural networks. arXiv preprint arXiv:1507.06149.
[12] Tishby, N.; Pereira, F. C.; and Bialek, W. 2000. The information bottleneck method. arXiv preprint physics/0004057.
[13] Wang, W.; Fu, C.; Guo, J.; Cai, D.; and He, X. 2019.Cop: Customized deep model compression via regularized correlation-based filter-level pruning. arXiv preprint arXiv:1906.10337.
[14] Zhai, X.; Kolesnikov, A.; Houlsby, N.; and Beyer, L.2021. Scaling vision transformers. arXiv preprint arXiv:2106.04560.

1. A method for pruning a neural network comprised of a plurality of neurons, the method comprising:
determining mutual information between outputs of two or more of the plurality of neurons and a respective two or more inputs used to generate the outputs, the two or more neurons being activated as a result of synthetically created inputs for measuring entropy; and
determining a sparser neural network by pruning the plurality of neurons based on the determined mutual information.

2. The method of claim 1, wherein the two or more inputs are synthetically created based on a distribution that captures all possible input values within a fixed range.

3. The method of claim 2, wherein the two or more inputs are populated by sampling the distribution.

4. The method of claim 2, wherein the distribution is a Gaussian distribution.

5. The method of claim 1, wherein determining mutual information comprises:
activating the neural network with the synthetically created inputs;
caching outputs of the plurality of neurons generated in response to the activation; and
determining mutual information based on the cached outputs.

6. The method of claim 1, wherein the two or more neurons are in a layer of the neural network, the wherein the method further comprises:
pruning a neuron of two or more neurons having a lower determined mutual information.

7. The method of claim 6, further comprising:
iteratively pruning another layer of the neural network based on determined mutual information of two or more neurons in the other layer.

8. The method of claim 7, wherein determined mutual information of the two or more neurons in the other layer is independent of the two or more neurons in the layer.

9. The method of claim 1, wherein each neuron of the two or more neurons outputs two or more neuron specific outputs based on receiving two or more neuron specific inputs.

10. The method of claim 1, wherein the mutual information is determined per input-output for the neuron.

11. A system for pruning a neural network comprised of a plurality of neurons, the system comprising:
a processor and memory, the memory comprising computer executable instructions which cause the processor to:
determine mutual information between outputs of two or more of the plurality of neurons and a respective two or more inputs used to generate the outputs, the two or more neurons being activated as a result of synthetically created inputs for measuring entropy; and
determine a sparser neural network by pruning the plurality of neurons based on the determined mutual information.

12. The system of claim 11, wherein the two or more inputs are synthetically created based on a distribution that captures all possible input values within a fixed range.

13. The system of claim 12, wherein the two or more inputs are populated by sampling the distribution.

14. The system of claim 11, wherein the processor, to determine mutual information:
activates the neural network with the synthetically created inputs;
caches outputs of the plurality of neurons generated in response to the activation; and
determines mutual information based on the cached outputs.

15. The system of claim 11, wherein the two or more neurons are in a layer of the neural network, and the processor:
prunes a neuron of two or more neurons having a lower determined mutual information.

16. The system of claim 15, wherein the processor further:
iteratively prunes another layer of the neural network based on determined mutual information of two or more neurons in the other layer.

17. The system of claim 16, wherein determined mutual information of the two or more neurons in the other layer is independent of the two or more neurons in the layer.

18. The system of claim 11, wherein each neuron of the two or more neurons outputs two or more neuron specific outputs based on receiving two or more neuron specific inputs.

19. The system of claim 11, wherein the mutual information is determined per input-output for the neuron.

20. A computer readable medium storing computer executable instructions which cause a processor to:
determine mutual information between outputs of two or more of a plurality of neurons and a respective two or more inputs used to generate the outputs, the two or more neurons being activated as a result of synthetically created inputs for measuring entropy; and
determine a sparser neural network by pruning the plurality of neurons based on the determined mutual information.
